(19) United States
(12) Patent Application Publication
(10) Pub. No.: US 2007/0050061 A1
(43) Pub. Date: Mar. 1, 2007

(54) Audio player remote control system

(75) Inventors: Andre Klein, Frankfurt (DE); Alexander Brezing, Aachen (DE)

Correspondence Address: STEPHEN D. SCANLON, JONES DAY, 901 LAKESIDE AVENUE, CLEVELAND, OH, 44114, US

(73) Assignee: Andre Klein

(21) Appl. No.: 11/216,440

(22) Filed: Aug. 31, 2005

(51) Int. Cl. G06F 17/00; H04B 1/00

(52) U.S. Cl. 700/94; 381/86

(57) ABSTRACT

This invention relates to accessories for audio players used for downloading, storing and playing of audio files, i.e. music or spoken word content. More specifically the invention relates to an audio player remote control system, in particular a power supply and charging unit for a digital audio player, which is coupled with a remote control receiver. The invention further relates to a remote control transmitter for controlling the digital audio player, which may be mounted on the vehicle's steering wheel. The remote control of the audio player prevents the driver from reaching to the often unfavorable located audio player for operating it which enhances safety during driving the vehicle. The power supply and charging unit, which has a built-in or external remote control receiver, can be attached to the digital audio player for providing power to the player and charging the player's battery. The remote control transmitter has an enclosure which is specifically designed to be attached to a steering-wheel. This design allows for a close and tight fitting of remote control transmitter and steering-wheel which results in a safe operation of the audio player by a driver of the vehicle. The remote control transmitter is designed so that the driver's fingers can easily reach control buttons without leaving the steering-wheel.

### BACKGROUND

1. Field of the Invention

This invention relates to accessories for audio players used for downloading, storing and playing of audio files, i.e. music or spoken word content. More specifically the invention relates to an audio player remote control system, in particular a power supply and charging unit for a digital audio player, which is coupled with a remote control receiver. The invention further relates to a remote control transmitter for controlling the digital audio player.

2. Description of the Related Art

Since the mid-1950s the electronic industry has searched for ways to offer consumers portable audio players with compact size. It all started with portable transistor radios, but it wasn't until 1979 when the world saw its first personal and portable audio revolution with the introduction of first truly portable audio cassette player. In 1983 a syndicate formed by leading entertainment electronics manufacturers released the Compact Disc—this event is often seen as the, Big Bang' of the digital audio revolution (previously audio content had to be stored analogue). Subsequently, portable Compact Disc players emerged. Caused by the limited bandwidth of the Internet in the mid-1990s, various audio compression formats were introduced, of which MP3 (correctly MPEG-1 layer 3) is probably the most popular one. MP3 encoded files are capable of being stored on a computer. In the next logical step in 1998, the world's first portable MP3 player was introduced. Many others followed, including Apple Computer, Inc. in 2001 with the iPod™.

Portable digital audio players are nowadays also commonly used in vehicles such as cars or boats. However, portable audio players are still ancillary devices in the vehicles and are not fully integrated in the driver's operating environment. The players are usually mounted at an inconvenient location in the interior of the vehicle, e.g. at the center console which can not be easily reached by the driver. Controlling the digital audio player, for instance skipping the currently playing audio track, therefore often distracts the vehicle's driver from paying attention to the traffic, as he or she has to reach for the control buttons located on the digital audio player. This distraction implies a serious risk for traffic accidents.

In addition, digital audio players are often portable devices which are only temporally used in the vehicle and usually taken along by the driver when leaving the vehicle. Thus, it is inconvenient if the audio player installation in the vehicle requires difficult procedures and the attachment of a plurality of devices, cables, and/or connectors.

Thus, there is a general need for a safe operation of the digital audio player in the vehicle.

There is a further need for a simple docking procedure of the digital audio player in the vehicle.

There is a further need for a remote control transmitter which can be closely and tightly fitted to the steering-wheel and allows safe operation by the driver.

### SUMMARY

The present invention overcomes the problems noted above and satisfies the above mentioned needs. The present invention relates to a remote control system for audio players and provides a power supply and charging unit, which is coupled with a remote control receiver and interconnects with a portable digital audio player such as the Apple iPod™. A corresponding remote control transmitter, which may be mounted on the vehicle's steering wheel, enables secure operation of the digital audio player. An optional additional hand-held remote control transmitter gives backseat passenger convenient control access to operate the audio player. The remote control of the audio player prevents the driver from reaching to the often unfavorable located audio player for operating it. This enhances safety during driving the vehicle.

The present invention provides a power supply and charging unit, which has a built-in or external (attached through a cable) remote control receiver. The invention can be attached to a digital audio player, providing power to the player and charging the player's battery. Various types of wireless remote controls can be employed to provide secure and convenient control access over the attached digital audio player.

When using a digital audio player in a vehicle such as a car, the player usually gets attached to a power supply/charging assembly which plugs into a standard cigarette lighter jack. Instead of additionally attaching a separate remote control receiver to the digital audio player, the present invention combines the remote control receiver with a power supply/charging assembly. This makes the docking process in the vehicle easy and convenient.

The present invention further provides a remote control transmitter having an enclosure which is specifically designed to be attached to a steering-wheel. This design allows for a close and tight fitting of remote control transmitter and steering-wheel which results in a safe operation of the audio player by a driver of the vehicle. The remote control transmitter is designed so that the driver's fingers can easily reach control buttons without leaving the steering-wheel.

The remote control transmitter enclosure is preferably formed as a counterpiece to a section of the steering-wheel matching the contour of the steering-wheel so that it can be mounted on the steering-wheel and fits in it. This enables a close and tight fitting.

The remote control transmitter enclosure may be attached radially inward or outward to the steering-wheel so that the control buttons may be arranged at the front side and the back side of the enclosure with respect to the driver. This allows a compact design of the enclosure and a placement of the control buttons close to the steering-wheel which enhances the reachability of the control buttons for the driver.

### BRIEF DESCRIPTION OF THE DRAWINGS

FIG. 1 is a schematic representation of an embodiment of the invention and shows how the individual components—power supply/charger and remote controlling receiver, both interconnected with a digital audio player and remote control transmitters—interact which each other.

FIG. 2a is a front view of a steering-wheel mountable remote control transmitter according to an embodiment of the invention.

FIG. 2b is a back view of a steering-wheel mountable remote control transmitter according to an embodiment of the invention.

FIG. 3 is a perspective view of a steering-wheel mountable remote control transmitter with individual components for mounting and operation of the device.

FIGS. 4a, 4b and 4c are illustrations showing schematically the arrangement of the remote control transmitter on a cross-section of a steering wheel.

FIGS. 5a, 5b, 5c and 5d show schematically the insertion of a battery in a steering-wheel remote control transmitter's battery compartment.

FIGS. 6a, 6b, 6c and 6d show schematically the process of mounting a remote control transmitter onto a steering-wheel.

### DETAILED DESCRIPTION

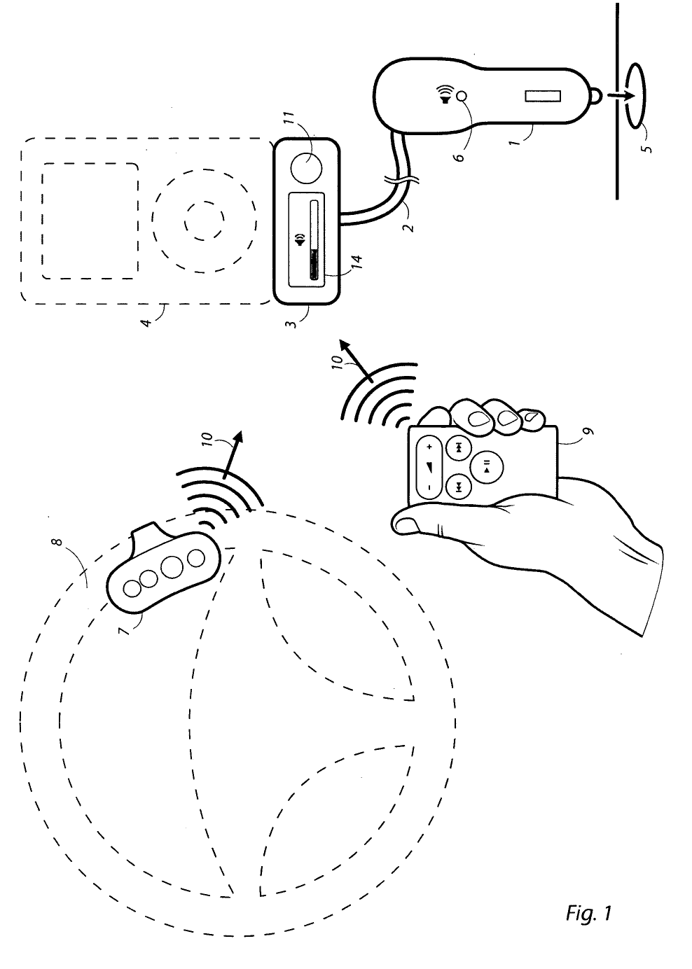

FIG.1 shows a power supply/charger 1 connected through a cable 2 with a control unit 3 including a remote control receiver and a controller, being attached to a digital audio player 4. Note that although in FIG.1 the power supply 1 and the control unit 3 are separated, both components may be located in the same enclosure which then connects through a cable with an appropriate plug at its end to the digital audio player 4. Optionally, the power supply 1, the control unit 3 may be located in one enclosure which is directly attached to the digital audio player 4.

According to the embodiment, the power supply and charging assembly 1 is attached to a power outlet 5 in the vehicle (typically 12 volts), as primarily used for cigarette lighters. An audio jack 6 located anywhere on the assembly 1 may provide a convenient option to establish a connection with an external audio system such as a car stereo using cassette adapters or direct wiring. The volume level provided from the audio jack 6 may be adjusted by the control unit 3. An optional display 14 may provide visual feedback on the current volume setting.

The control unit 3 comprises docking means for attaching the audio player 4. An audio player interface for electrically connecting the audio player 4 to the control unit 3 is arranged in the docking means. The audio player interface may be configured to send commands to the audio player, receive status information from the audio player, and/or receive an audio signal from the audio player. In addition, electric power may be supplied from the power supply 1 via the audio player interface to the audio player 4. Thus, it is only necessary to connect the audio player 4 with the single audio player interface, by attaching the audio player 4 to the docking means, for operating the audio player 4 in a vehicle. Then, the audio player 4 can be controlled by the remote control receiver and receives electric power for its operation. It is not necessary to attach additional devices to the audio player 4, e.g. as known from prior art where a remote control receiver and a power supply unit have to be separately connected to the audio player 4. The present invention simplifies the docking and handling of the audio player 4 and allows for a convenient operation.

A remote control transmitter 7 designed to be mounted on the steering wheel 8 gives the driver hassle-free control over the digital audio player 4 and allows him to focus on the traffic.

Optionally, a hand-held remote control 9 giving backseat passengers conveniently access on controlling the digital audio player 4 may be provided.

The command transmission 10 between the remote control transmitters 7, 9 and the remote control receiver may be of analogue (such as FM) or digital (such as Bluetooth) type.

The controller may comprise a programmable micro-controller and a memory unit for storing programs and data. The micro-controller may interpret received control commands and generate respective control signals to control the audio player 4. The control of the audio player may include the generation of analog or digital control signals which are communicated to the audio player 4 via the audio player interface, typically using a serial remote protocol.

Remote control commands being directed to the digital audio player may include Start Playback, Pause Playback, Stop Playback, Rewind, Previous Track, Fast Forward, Next Track, Playback Volume Up, Playback Volume Down and others.

Each remote control transmitter 7, 9 may send its commands together with an encoded identifier. The identifier may be either unique or taken from a pool of identifiers. The remote control receiver may only react to those remote control transmitters 7, 9 which identifiers previously have been assigned to the remote control receiver. This assignment process is to avoid accidental control of the digital audio player 4 from extraneous remote controls. A typical situation would be two cars, both being equipped with a power supply/charging unit having a remote receiver, and being further equipped with an audio player and a remote control transmitter, standing next to each other at a traffic light. As the identifiers of the remote control transmitters 7, 9 have to be assigned to the respective remote control receiver in order to work, the passengers of car A can't control the digital audio player in car B and vice-versa.

The identifier assignment process may be initiated by pressing a button 11 on the control unit 3. Within a certain time frame, the remote control receiver accepts remote commands from any remote control transmitter 7, 9 within transmission range. Pressing any button on a remote control transmitter 7, 9 tells the remote control receiver the transmitter's identifier. This identifier gets stored in a non-volatile memory of the control unit 3. After the given assignment time frame has elapsed, the remote control receiver 3 only reacts to those remote control transmitters 7, 9, which identifiers the control unit 3 has stored.

Throughout the assignment process, the display 14 will provide visual feedback to the user. The display may further be used to provide information on the volume level, provide general status information on the control unit or provide information on setting additional preferences of the remote control receiver. Alternatively, if the remote control receiver is built without display, one or more status LEDs positioned at the control unit 3 may provide visual feedback.

The audio player interface may be configured to allow access to the audio player, send commands to the audio player, receive status information from the audio player, and receive the audio signal from the audio player. The audio signal may be an analog or digital signal and may be processed in the controller prior to outputting the audio signal at the audio jack 6, e.g. to adjust the volume of the audio signal.

The invention may be implemented as a first unit housing the control unit 3 (remote control receiver and controller) and a separate second unit housing the power supply/charging assembly 1. The first unit can be attached to the digital audio player 4 via docking means. The docking means may include a cable and/or a connector for electrically connecting to the digital audio player 4. Alternatively, the remote control receiver, the controller and the power supply/charging assembly 1 may be integrated and arranged in one single combined housing.

The shape/design of the housing may be designed such that it fits to the external shape of the digital audio player 4 and allows for a physical close attachment thereto. In one preferred embodiment of the invention, the first unit's housing is configured to take in and house the digital audio player 4 at least partially so that the combination of digital audio player 4 and control unit 3 form a compact unit which can be fitted to the interior of a vehicle, e.g. by means of a dashboard cradle.

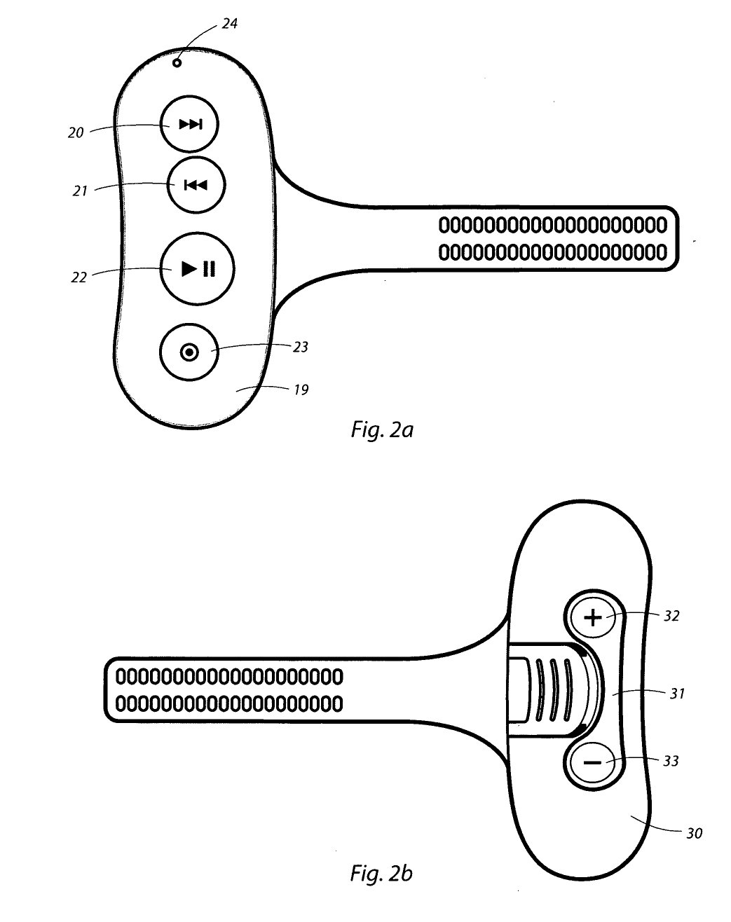

FIG. 2a is a front view of a steering-wheel mountable remote control transmitter 7 according to an embodiment of the invention. The front side of the enclosure 19 may incorporate buttons 20-23 for the most commonly used functions on controlling the digital audio player 4, such as Next Track/Fast Forward 20, Previous Track/Rewind 21 and Play/Pause 22 as well as a multi-functional button 23 e.g. to wirelessly control a mobile phone (not shown). Because of the convenient position of the remote control transmitter 7 on the steering wheel 8, all buttons 20-23 on the front side may be designed for activation using the user's thumb. Buttons which may be frequently used, such as buttons 20, 21, 22, may have a convex shape, while buttons which may only be used occasionally, such as button 23, may have a concave shape to avoid accidental activation.

The enclosure 19 may also comprise a microphone 24 which may be used to pick up the driver's voice so it can be wirelessly send to a mobile phone. A typical application would be voice-activated phone calls, where the driver speaks a command plus the name of a person whose phone number is stored in the driver's mobile phone's address book, and the mobile phone establishes a call to that person thereafter. The microphone 24 may also be used to pick up the driver's voice during a telephone conversation, which therefore allows hands-free operation.

FIG. 2b is a back view of a steering-wheel mountable remote control transmitter 7 according to an embodiment of the invention. The back side 30 of the enclosure 19 may incorporate a rocker switch 31 to control the volume using the remote control receiver 3 in FIG. 1. To distinguish the volume-up button 32 from the volume-down button 33, one button may have a convex shape while the other may have a concave shape. Because of the convenient position of the remote control transmitter 7 on the steering wheel 8, all buttons 32, 33 on the back side 30 may be designed for activation using the middle finger or index finger of the user.

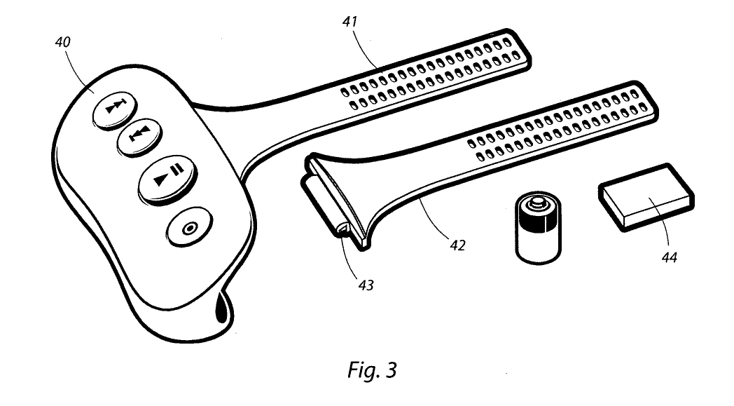

FIG. 3 is a perspective view of a steering-wheel mountable remote control transmitter 7 according to an embodiment of the invention with individual components for mounting and operation of the device. For mounting the remote control transmitter enclosure 40 on the steering-wheel 8, a belt 41 may be used. A user-replaceable spare belt 42 may be provided. The belt 41 is attached to the enclosure 40 through a hole 43 using a pin similar to those used to mount wristwatch belts. A self-adhesive foam pad 44 may be used to improve stability of the enclosure 40 on steering-wheels with a small profile, e.g. wooden steering-wheels.

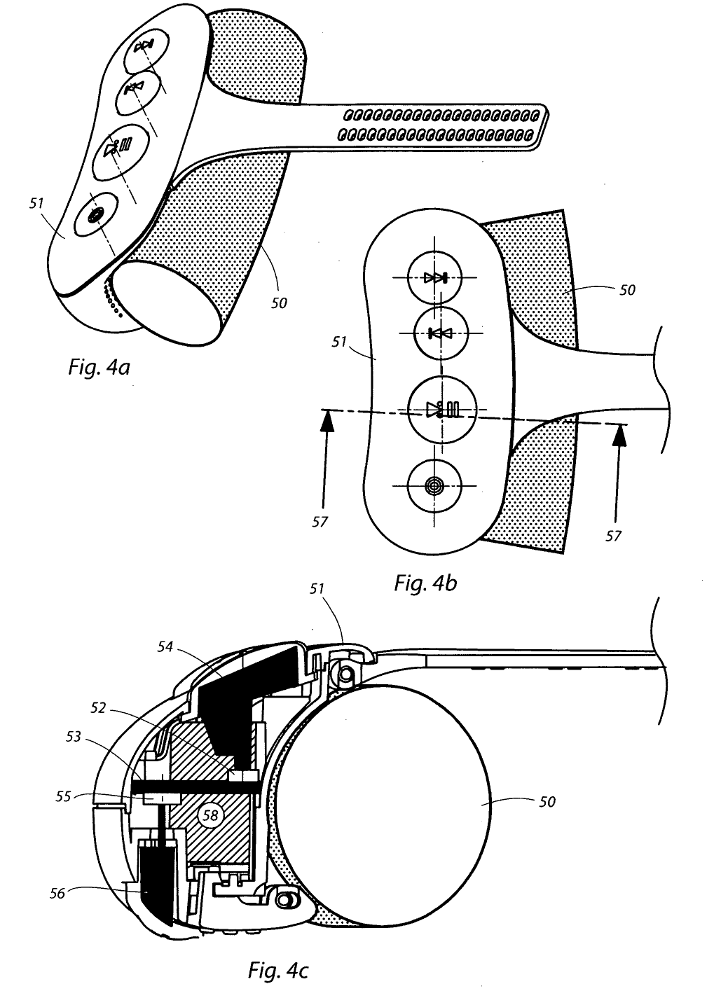

FIG. 4a is a perspective view showing a section of steering-wheel 50 with a remote control transmitter enclosure 51 according to an embodiment of the invention mounted, i.e. closely attached to the steering wheel 50.

FIG. 4b is a top view showing a section of steering-wheel 50 with the mounted remote control transmitter 51 mounted. The dotted line 57 represents the cross-cut as shown in FIG. 4c.

FIG. 4c is a cross-sectional view showing how the remote control transmitter's enclosure 51 overlaps with the steering-wheel 50. The tactile switches 52 may be located on the outmost edge of the circuit board 53. Thus, the push buttons 54 on the front side of the remote control transmitter 7 may overlap the steering-wheel 50, allowing the curved design of the remote control transmitter's enclosure 51 to seamlessly blend into the shape of the steering-wheel 50, giving the impression that the remote control transmitter 7 is actually “built into” the steering-wheel 50. Thus, the push buttons 54 seem to be arranged “on” the steering wheel 50 and not adjacent to the steering wheel 50. The circuit board 53 and the switches 52 may indeed be located next to the steering wheel 50. This is a major difference to existing steering-wheel remote controls, which mostly look clunky and out of place, and are difficult to operate as the buttons are not easily accessible for the user's fingers without opening the grip of the steering-wheel. The volume rocker 56 may use tactile switches 55 arranged on the bottom side of the circuit board 53. The battery compartment 58 may intersect with the circuit board 53 for saving precious space, thus allowing the remote control transmitter's enclosure 51 to further blend into the steering-wheel 50.

According to the illustrated embodiment, the transmitter enclosure 51 has a cylindrical recess for accepting a section of the steering wheel 50 when being attached to the steering-wheel 50. Thus, the transmitter 7 fits exactly to the steering-wheel 50 so that a tight fitting is achieved.

The fitting can be further improved if the transmitter enclosure 51 is curved for fitting to the interior or exterior circumference of the steering-wheel 50. The side of the transmitter enclosure 51 facing the steering-wheel 50 may be shaped as part of an annulus which preferably corresponds to the circular arc section of the steering-wheel 50 covered by the enclosure 51. Thus, the transmitter enclosure 51 has a twofold annular form in two orthogonal directions. The above exterior design of the enclosure 51 allows for a good and tight fit of enclosure 51 and steering-wheel 50. In addition, the buttons may be arranged close to the steering-wheel 50 for facilitating their operation.

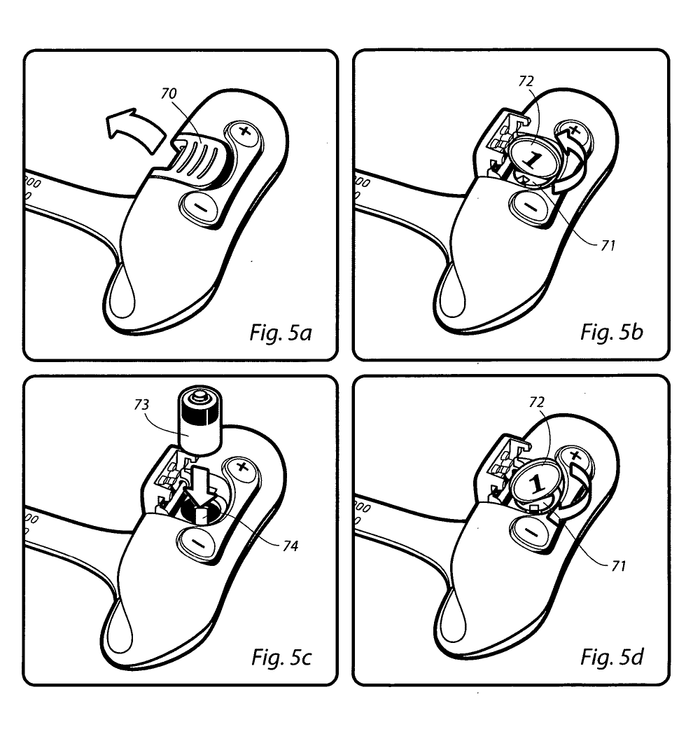

FIG. 5a is a back view of a remote control transmitter 7 according to an embodiment of the invention. Opening a belt lever 70 reveals the battery compartment cover 71 as shown in FIG. 5b. The battery compartment cover 71 has a thread to be screwed in the housing and a groove on its upper surface. Thus, the battery compartment cover 71 may be unlocked using a small coin 72. After unlocking, the battery compartment cover 71 is easily removable. FIG. 5c shows the battery 73 being inserted into the open battery compartment 74. FIG. 5d shows the battery compartment cover 71 being locked again using a coin 72. The locked battery compartment cover 71 closes the battery compartment 74 and secures the inserted battery 73. The battery compartment cover 71 itself is covered by the belt lever 70 being in the locked position so that it is not visible from the outside.

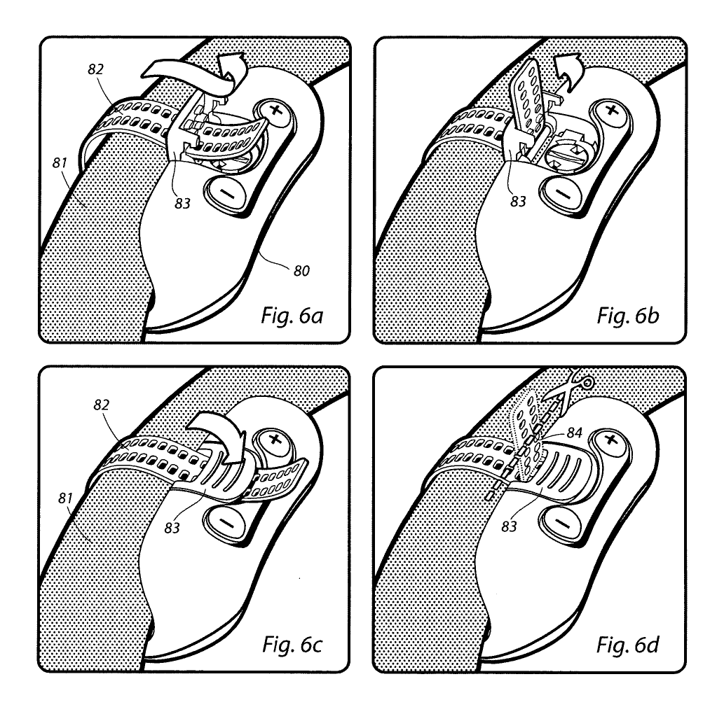

FIG. 6a is a back view of a remote control transmitter enclosure 80 according to an embodiment of the invention being mounted onto a steering-wheel 81. A belt 82 is drawn through a belt lever 83 for clamping the belt 82. FIG. 6b shows the belt 82 being pulled and belt pinholes engaging with pins on the belt lever 83. FIG. 6c shows the belt lever 83 being closed, which further pulls the belt 82 against the steering-wheel 81. This tightens the fitting of the enclosure 80 with the steering-wheel 81. FIG. 6d shows that the exceeding portion of the belt 84 may be cut, if the remote control transmitter enclosure 80 sits tight enough. To do so the belt lever 83 may have to be lifted again. After cutting the belt, the belt lever 83 is closed again and the control transmitter enclosure 80 sits tight on the steering-wheel 81.

Although the present invention is described by referring to preferred embodiments, it will be clear to a skilled person that it is not limited to the disclosed embodiments and modifications may be made without departing from the spirit and scope of the invention as set forth by the accompanying claims.

1. A remote control and power supply assembly for an audio player, comprising:
a remote control receiver for receiving remote control commands from a remote control transmitter;
an audio player interface electrically coupleable with the audio player;
a controller for controlling, via the audio player interface, the audio player based on the received remote control commands;
a power supply unit for supplying, via the audio player interface, electric power to the audio player; and
docking means for attaching the audio player, the audio player interface being arranged in the docking means.

2. The assembly of claim 1, wherein the remote control receiver, the controller and the power supply unit are arranged in a main body.

3. The assembly of claim 1, wherein the remote control receiver and the controller are arranged in a main body, the power supply unit being connected to the main body through a cable.

4. The assembly of claim 1, wherein the docking means comprise a connector for electrically connecting the audio player when attached to the docking means.

5. The assembly of claim 1, having an audio coupling means for connecting the audio output of the audio player with an external audio system.

6. The assembly of claim 5, wherein the audio coupling means comprises a socket for connecting a cable to the external audio system.

7. The assembly of claim 1, wherein the controller is configured to detect a remote control identifier received with a remote control command from a remote control transmitter for identifying the remote control transmitter.

8. The assembly of claim 7, wherein the controller comprises a memory means for storing at least one remote control identifier received during a registration phase for a remote control transmitter.

9. The assembly of claim 8, wherein the controller is configured to compare a remote control identifier received with a remote control command with the at least one stored remote control identifier for determining if the received control command will be accepted.

10. The assembly of claim 1, comprising a display for displaying control command information and/or audio player status information.

11. The assembly of claim 1, wherein the audio player interface is configured to allow at least one of: sending commands to the audio player, receiving status information from the audio player, and receiving an audio signal from the audio player.

12. The assembly of claim 1, comprising a remote control transmitter being adapted to be mounted to a steering wheel of a vehicle.

13. A sound system including a remote control and power supply assembly according to claim 1, at least one remote control transmitter and a digital audio player connected to the audio player interface.

14. A remote control transmitter for transmitting audio player control commands, comprising:
a plurality of control buttons;
a control unit for reading an activation of at least one control button and generating a control command;
a radio transmitter for transmitting the control command received from the control unit; and
a transmitter enclosure being adapted to be attached to a steering wheel;
wherein the transmitter enclosure has a cylindrical recess for accepting the steering wheel when being attached to the steering wheel.

15. The remote control transmitter of claim 14, wherein the transmitter enclosure is curved for fitting to the interior or exterior circumference of the steering wheel.

16. The remote control transmitter of claim 14, having a belt and a belt lever for fixing the transmitter enclosure to the steering wheel.

17. The remote control transmitter of claim 16, wherein the belt lever has pins and the belt has pinholes for engaging in the pins, and wherein the belt is tightened when the belt lever is turned down.

18. The remote control transmitter of claim 14, wherein a control button has a concave or convex surface.

19. The remote control transmitter of claim 14, wherein control buttons are arranged at the front side and the back side of the enclosure.

20. The remote control transmitter of claim 19, wherein switches being operated by the control buttons are located on two sides of a circuit board arranged in the transmitter enclosure.

21. The remote control transmitter of claim 19, wherein at least one control button is arranged partially overlapping the steering wheel.
